(19) United States
(12) Patent Application Publication
(10) Pub. No.: US 2010/0077359 A1
(43) Pub. Date: Mar. 25, 2010

(54) MAP DISPLAY DEVICE

(76) Inventor: Yoshihiro Shinawaki, Tokyo (JP)

Correspondence Address: BIRCH STEWART KOLASCH & BIRCH, PO BOX 747, FALLS CHURCH, VA, 22040-0747, US

(21) Appl. No.: 12/312,911

(22) PCT Filed: Sep. 28, 2007
(86) PCT No.: PCT/JP2007/069054

§ 371 Date: Jun. 1, 2009

(30) Foreign Application Priority Data
Dec. 19, 2006 (JP) 2006-341229

(51) Int. Cl. G06F 3/048; G01C 21/00

(52) U.S. Cl. 715/846

(57) ABSTRACT

A map display device includes a display condition judging means 13 for judging whether or not a display condition for changing display priorities of icons is satisfied, an overlap judging means 14 for judging whether an icon to be displayed has an overlap with another icon when the display condition judging means judges that the display condition is satisfied, a display state changing means 15 for, when the overlap judging means judges that an icon to be displayed has an overlap with another icon, changing the display priorities automatically in such a way that an icon which has been judged to satisfy the display condition by the display condition judging means is displayed on a priority basis, and a display means 16 and 6 for displaying icons according to the display priorities changed by the display state changing means.

### FIELD OF THE INVENTION

The present invention relates to a map display device that displays a map. More particularly, it relates to a technology of displaying icons for POIs (Points of Interests) on a map.

### BACKGROUND OF THE INVENTION

Conventionally, a map display device for use in, for example, a vehicle-mounted navigation apparatus is known. This conventional map display device displays a map on the basis of map data stored in a map database, and also superimposes and displays POI icons on this map. A POI refers to something such as a facility shown as a point on a map, e.g., a parking lot, a gas station, a convenience store, a hospital, or a hotel. The conventional map display device also emphasizes and displays POI icons in a characteristic form in order to make the map visible.

As such a technology of displaying icons, for example, patent reference 1 discloses a map display device that can change its display mode to display a map according to a utilization history, thereby providing good visibility. This map display device includes a map information acquiring means for acquiring map data, a display means for displaying a map on the basis of map elements included in the map data acquired by the map information acquiring means, a utilization history storage means for storing, as utilization history information, the use state of the map elements included in the map data acquired by the map information acquiring means, and a display control means for changing the map elements according to the utilization history information stored in the utilization history storage means to cause the display means to display the map.

[Patent reference 1] JP, 2005-352170,A

In accordance with the technology disclosed by above-mentioned patent reference 1, when a requirement of, for example, the number of times that a search for a POI has been performed exceeding a predetermined number of times is satisfied, the display form of an icon for the POI is changed by, for example, enlarging the icon for the POI displayed on the map automatically. A problem is, however, that when, for example, another facility exists near a facility whose icon has been enlarged, their POI icons may overlap each other and the visibility is worsened. Furthermore, although a technology of allowing the user to enable or disable the display of each and every type of POI icon is known, a problem with the technology is that because the user needs to perform a setting operation, it is user-unfriendly.

The present invention is made in order to solve the above-mentioned problems, and it is therefore an object of the present invention to provide a map display device which provides good visibility and which also has user-friendness.

### DISCLOSURE OF THE INVENTION

In order to achieve the above-mentioned object, there is provided a map display device including: a display condition judging means for judging whether or not a display condition for changing display priorities of icons is satisfied; an overlap judging means for judging whether an icon to be displayed has an overlap with another icon when the display condition judging means judges that the display condition is satisfied; a display state changing means for, when the overlap judging means judges that an icon to be displayed has an overlap with another icon, changing the display priorities automatically in such a way that an icon which has been judged to satisfy the display condition by the display condition judging means is displayed on a priority basis; and a display means for displaying icons according to the display priorities changed by the display state changing means.

The map display device in accordance with the present invention judges whether or not the display condition for changing the display priorities of icons is satisfied, and, when the display condition is satisfied, further judges whether an icon to be displayed has an overlap with another icon, and, when an icon to be displayed has an overlap with another icon, automatically displays an icon which has been judged to satisfy the display condition on a priority basis. Therefore, by defining the display condition properly, the map display device can provide good visibility and can also have user friendness.

### BRIEF DESCRIPTION OF THE FIGURES

FIG. 1 is a block diagram showing the structure of a vehicle-mounted navigation apparatus to which a map display device in accordance with Embodiment 1 of the present invention is applied;

FIG. 2 is a view showing an example of a display produced by the map display device in accordance with Embodiment 1 of the present invention;

FIG. 3 is a functional block diagram showing the functional structure of a navigation ECU for use in the map display device in accordance with Embodiment 1 of the present invention;

FIG. 4 is a view for explaining a display condition for changing the display state of a POI icon which is used by the map display device in accordance with Embodiment 1 of the present invention;

FIG. 5 is a flow chart for explaining the operation of the map display device in accordance with Embodiment 1 of the present invention;

FIG. 6 is a view for explaining a change in the display screen of the map display device in accordance with Embodiment 1 of the present invention, and shows a map before a search is performed;

FIG. 7 is a view for explaining a change in the display screen of the map display device in accordance with Embodiment 1 of the present invention, and shows a menu screen in a case of searching for restaurants in the vicinity of a hotel;

FIG. 8 is a view for explaining a change in the display screen of the map display device in accordance with Embodiment 1 of the present invention, and shows a map which is acquired through a first-time search, and

FIG. 9 is a view for explaining a change in the display screen of the map display device in accordance with Embodiment 1 of the present invention, and shows a map which is acquired after a search has been performed a predetermined number of times or greater.

### PREFERRED EMBODIMENTS OF THE INVENTION

Hereafter, in order to explain this invention in greater detail, the preferred embodiments of the present invention will be described with reference to the accompanying drawings.

Hereafter, a map display device in accordance with any of the embodiments of the present invention will be explained by assuming that it is applied to a vehicle-mounted navigation apparatus.

### Embodiment 1

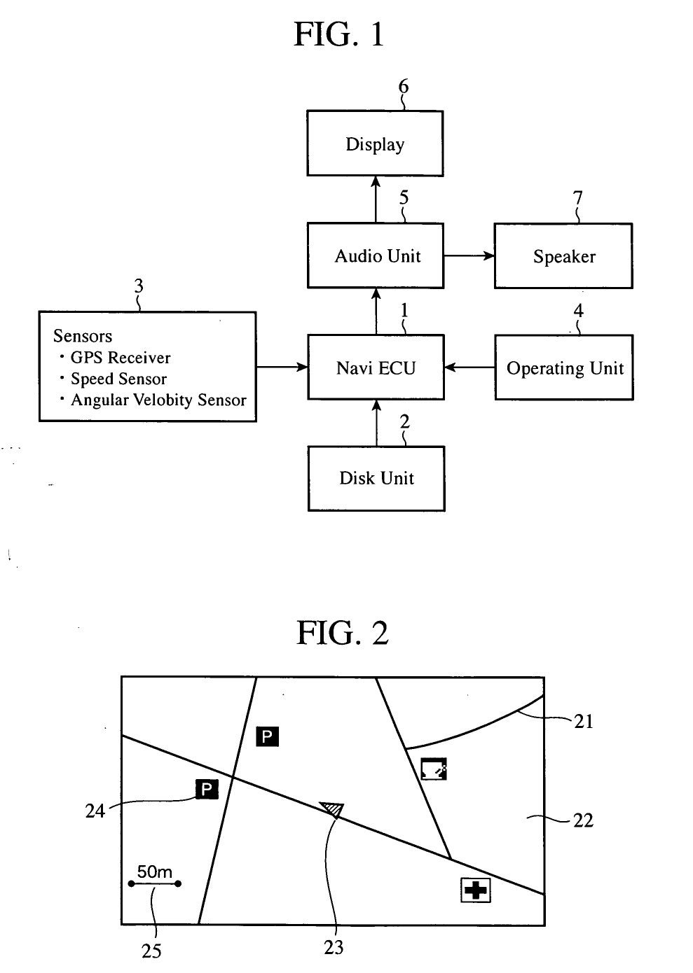

FIG. 1 is a block diagram showing the structure of a vehicle-mounted navigation apparatus to which a map display device in accordance with Embodiment 1 of the present invention is applied. This vehicle-mounted navigation apparatus is comprised of a navigation ECU (abbreviated as a “navi ECU” from here on) 1, a disk unit 2, sensors 3, an operating unit 4, an audio unit 5, a display 6, and a speaker 7.

The navi ECU 1 controls the whole vehicle-mounted navigation apparatus. For example, the navi ECU 1 carries out a process of implementing navigation functions, such as a map display, a route search, and a route guidance. The details of this navi ECU 1 will be mentioned below.

The disk unit 2 consists of, for example, an HDD (Hard Disk Drive), and stores map data, POI data, and screen data. The map data are used in order to draw a map, the POI data are used in order to draw POI icons, and the screen data are used in order to draw a compass or produce a screen display except for the map. The map data, the POI data, and the screen data which are stored in this disk unit 2 are read by the navi ECU 1.

As the disk unit 2, a DVD (Digital Versatile Disk) drive or a CD (Compact Disc) drive can be alternatively used. In this case, when a DVD or a CD in which the map data, the POI data, and the screen data are recorded is mounted thereto, the DVD drive or the CD drive reads the POI data and the screen data from this medium and sends the POI data and the screen data to the navi ECU 1.

The sensors 3 are comprised of, for example, a GPS (Global Positioning System) receiver, a speed sensor, an angular velocity sensor, and so on. The GPS receiver detects the current position of the vehicle on the basis of GPS signals received, via an antenna, from GPS satellites, and sends the current position of the vehicle to the navi ECU 1 as current position data. The speed sensor detects the traveling speed of the vehicle on the basis of a signal sent thereto from the vehicle, and sends the traveling speed of the vehicle to the navi ECU 1 as speed data. The angular velocity sensor detects the traveling direction of the vehicle, and sends the traveling direction of the vehicle to the navi ECU 1 as direction data. The navi ECU 1 detects the current position of the vehicle with self-contained navigation on the basis of both the speed data from the speed sensor and the direction data from the angular velocity sensor. Because the vehicle-mounted navigation apparatus can detect the current position of the vehicle with self-contained navigation even if the vehicle-mounted navigation apparatus cannot detect the current position of the vehicle using the GPS receiver when, for example, the vehicle is traveling through a tunnel, the vehicle-mounted navigation apparatus can always detect the current position of the vehicle correctly.

The operating unit 4 can consist of, for example, a remote controller (referred to as a “remote control” from here on), a touch panel mounted on the screen of the display 6, a voice recognition unit that recognizes a voice inputted from a not-shown microphone, an operation switch disposed in a front panel of the vehicle-mounted navigation apparatus, and so on. This operating unit 4 is used in order for a user to provide various instructions to the vehicle-mounted navigation apparatus. Operation data inputted from this operating unit 4 are sent to the navi ECU 1.

The display 6 and the speaker 7 are connected to the audio unit 5. The audio unit 5 sends audio data sent thereto from the navi ECU 1 to the speaker 7. This audio unit 5 is also used as an interface for sending display data sent thereto from the navi ECU 1 to the display 6.

The display 6 corresponds to a part of a display means of the present invention, and displays a map, POI icons, and other various messages on the basis of the display data sent thereto, via the audio unit 5, from the navi ECU 1. The speaker 7 outputs music or a guiding voice on the basis of the audio data sent thereto, via the audio unit 5, from the navi ECU 1.

In the vehicle-mounted navigation apparatus constructed as mentioned above, the navi ECU 1 determines the current position thereof on the basis of the data sent from the sensors 3 (concretely, the GPS receiver, the speed sensor, and the angular velocity sensor). The navi ECU then reads map data and POI data about an area surrounding the determined current position from the disk unit 2, generates display data for drawing a map and POI icons on the basis of these map data and POI data which the navi ECU has read, and sends the display data to the display 6 via the audio unit 5. As a result, a vehicle position mark 23, POI icons 24, a map scale 25, and so on are displayed on the screen of the display 6 while they are superimposed on a map 22, as shown in FIG. 2, including roads 21.

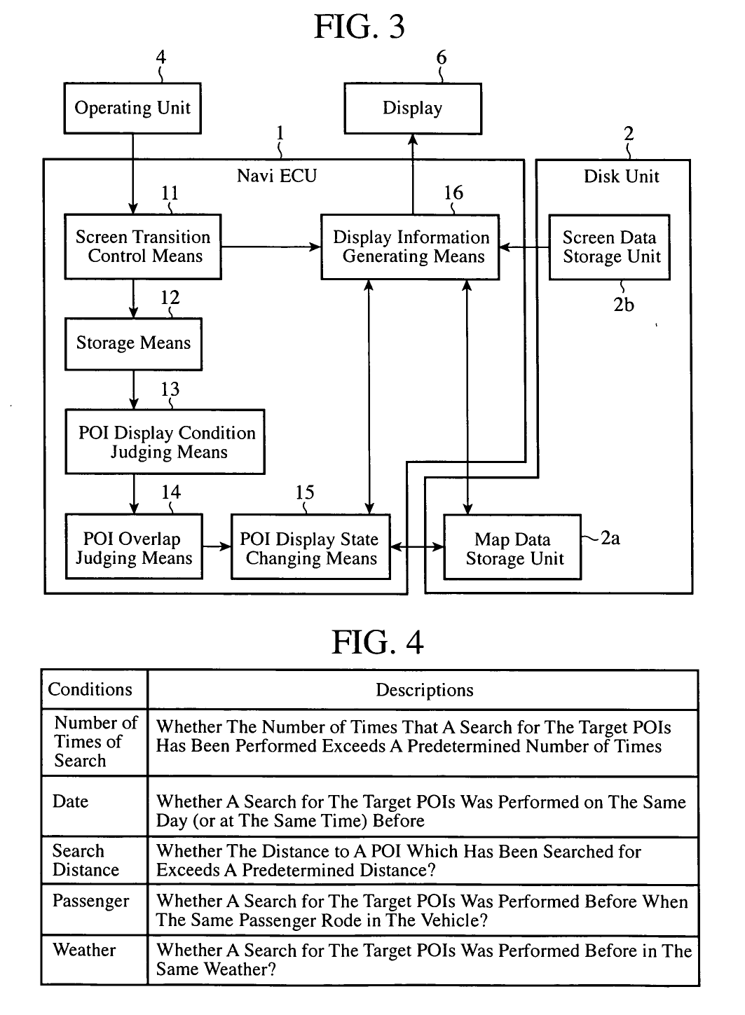

Next, the details of the navi ECU 1 will be explained. FIG. 3 is a functional block diagram showing the functional structure of the navi ECU 1. The disk unit 2 is comprised of a map data storage unit 2a and a screen data storage unit 2b. The map data storage unit 2a stores the map data and the POI data. The screen data storage unit 2b stores the screen data.

The navi ECU 1 consists of, for example, a microcomputer, and includes a screen transition control means 11, a storage means 12, a POI display condition judging means 13, a POI overlap judging means 14, a POI display state changing means 15, and a display information generating means 16. The screen transition control means 11, the POI display condition judging means 13, the POI overlap judging means 14, the POI display state changing means 15, and the display information generating means 16 are implemented via application programs which are executed by the microcomputer, and the storage means 12 consists of memories included in the microcomputer.

The screen transition control means 11 controls a transition to a navigation screen, the transition corresponding to operation data sent thereto from the operating unit 4. More specifically, the screen transition control means 11 controls a transition to a screen according to a user's operation. When making a transition to a screen, this screen transition control means 11 sends screen transition information showing the transition to the storage means 12, and also sends a screen transition request to the display information generating means 16.

The storage means 12 stores the screen transition information sent thereto from the screen transition control means 11 as screen transition history information. The screen transition history information stored in this storage means 12 is read by the POI display condition judging means 13.

The POI display condition judging means 13 corresponds to a display condition judging means of the present invention, and judges whether or not a display condition for changing the display priorities of POI icons which exist on the map is satisfied. As this display condition, as shown in FIG. 4, the number of times that a search for POIs has been performed which can be acquired from the screen transition history information stored in the storage means 12 is used. More specifically, the POI display condition judging means 13 judges that the display condition is satisfied when the number of times that a search for POIs to be drawn (referred to as the “target POIs” from here on) has been performed exceeds a predetermined number of times. The judgment result acquired by this POI display condition judging means 13 is sent to the POI overlap judging means 14.

As the display condition, for example, a date, a search distance, a passenger, or weather, other than the number of times that a search for the target POIs has been performed can be used, as shown in FIG. 4. In the case of a “date”, the display condition is whether a search for the target POIs was performed on the same day or at the same time before. This date can be acquired from a clock. In the case of a “search distance”, the display condition is whether or not for the distance to a POI which has been searched for exceeds a predetermined distance (a long distance). This search distance can be calculated on the basis of the map data. In the case of a “passenger”, the display condition is whether or not a search for the target POIs was performed before when the same passenger rode in the vehicle. The passenger can be identified from, for example, an ID which is inputted to the navi ECU when the engine of the vehicle is started. In the case of “weather”, the display condition is whether or not a search for the target POIs was performed before in the same weather. The weather can be judged from, for example, whether or not the wiper of the vehicle is operating. The display condition is not limited to the use of one of the number of times that a search has been performed, a date, a search distance, a passenger, and weather, and an arbitrary combination of some of them can be alternatively used as the display condition.

The POI overlap judging means 14 corresponds to a overlap judging means of the present invention, and judges whether or not a POI icon to be displayed has an overlap with another POI icon when the judgment result sent from the POI display condition judging means 13 shows that the display condition is satisfied. When two POIs exist close to each other, their POI icons may overlap each other. The judgment result acquired by this POI overlap judging means 14 is sent to the POI display state changing means 15.

The POI display state changing means 15 corresponds to a display state changing means of the present invention, and, when the judgment result sent from the POI overlap judging means 14 shows that a POI icon to be displayed has an overlap with another POI icon, raises the priority of the display of a POI icon which has been judged to satisfy the display condition by the display condition judging means 13 in such a way that the POI icon is displayed on a priority basis. More specifically, the POI display state changing means 15 acquires the POI data about the POI icons to be displayed from the map data storage unit 2a, and changes the display state of the POI icons on the map. The POI data showing the POI icons whose display state has been changed by this POI display state changing means 15 are sent to the display information generating means 16.

The display information generating means 16 corresponds to another part of the display means of the present invention, and acquires screen data from the screen data storage unit 2b according to the screen transition request sent from the screen transition control means 11 and generates display data for displaying a menu screen. The display information generating means also acquires data indicating the current display priorities of the POI icons from the POI display state changing means 15, and the map data for displaying a map about an area surrounding the current position of the vehicle from the map data storage unit 2a and the POI data showing the POI icons to be displayed on the map, and generates display data for displaying them on the screen. The display data generated by this display information generating means 16 are sent to the display 6.

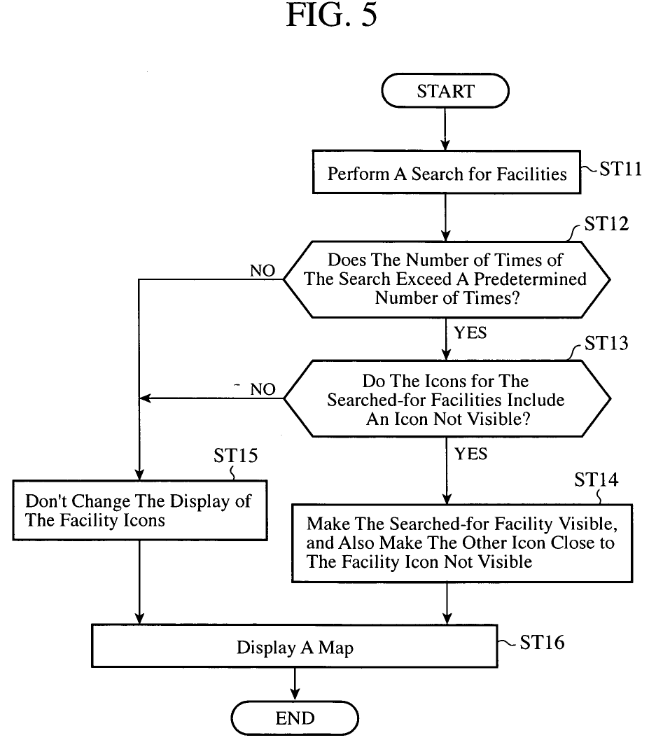

Next, the operation of the vehicle-mounted navigation apparatus to which the map display device constructed as mentioned above in accordance with Embodiment 1 of the present invention is applied will be explained with reference to a flow chart shown in FIG. 5, focusing on processes performed by the POI display condition judging means 13 and the POI overlap judging means 14. Hereafter, a case in which “facilities” are used as POIs will be explained.

First, the vehicle-mounted navigation apparatus performs a search for facilities (step ST11). More specifically, for example, the user operates the operating unit 4 to cause the vehicle-mounted navigation apparatus to perform a search for facilities. Operation data which have been generated through the user's operation of this operating unit 4 are sent to the screen transition control means 11. When making the map display device make a transition between screens according to the operation data, the screen transition control means 11 sends, as screen transition history information, screen transition information showing the transition to the storage means 12 to make the storage means store the screen transition information.

The map display device then checked to see whether the number of times that a search for facilities to be drawn (referred to as “target facilities” from here on) has been performed exceeds a predetermined number of times (step ST12). More specifically, the POI display condition judging means 13 calculates the number of times that a search for the target facilities has been performed from the screen transition history information stored in the storage means 12, and then checks to see whether the calculated number of times exceeds the predetermined number of times. In other words, the POI display condition judging means checks to see whether the display condition for changing the display priorities of the POI icons which exist on the map is satisfied. In this case, when the number of times that a search for the target facilities has been performed exceeds the predetermined number of times, the POI display condition judging means judges that the display condition is satisfied.

When the POI display condition judging means, in this step ST12, judges that the number of times that a search for the target facilities has been performed exceeds the predetermined number of times, the map display device then checks to see whether the icons for the target facilities which have been searched for in step ST11 include an icon not visible (step ST13). More specifically, when the judgment result sent from the POI display condition judging means 13 shows that the display condition is satisfied, the POI overlap judging means 14 checks to see whether each of the facility icons to be displayed has an overlap with another icon. That is, the POI overlap judging means checks to see whether or not there is a facility icon not visible because the facility icon has an overlap with another icon.

When the POI overlap judging means, in this step ST13, judges that there is a facility icon not visible, the map display device makes the facility icon, which has been searched for in step ST11, visible, and also makes the other icon, which is close to the facility icon, not visible (step ST14). More specifically, when the judgment result sent from the POI overlap judging means 14 shows that a facility icon to be displayed has an overlap with another icon, the POI display state changing means 15 raises the priority of the display of the facility icon in such a way that the facility icons which has been judged to satisfy the display condition by the display condition judging means 13 is displayed on a priority basis. More concretely, the POI display state changing means 15 acquires the data about the facility icons to be displayed from the map data storage 2a to change the display priority of the facility icons on the map. As a result, when a facility icon which has been searched for has an overlap with another icon which has been searched for, the facility icon whose number of times that a search for facilities has been performed is larger is displayed automatically.

After that, the vehicle-mounted navigation apparatus advances the sequence to step ST16 and performs the map display. More specifically, the display information generating means 16 acquires data indicating the current display state of the facility icons from the POI display state changing means 15 and also acquires the map data for displaying a map about an area surrounding the current position of the vehicle and the POI data showing the POI icons to be displayed on the map from the map data storage unit 2a, and generates display data for displaying them on the screen. The display data generated by this display information generating means 16 are sent to the display 6. As a result, the map including the facility icons whose number of times of search is larger on a priority basis is displayed on the screen of the display 6.

When it is judged, in above-mentioned step ST12, that the number of times that a search for the target facilities has been performed does not exceed the predetermined number of times, and when it is judged, in above-mentioned step ST13, that the icons for the facilities which have been searched for in step ST11 do not include any icon not visible, the map display device does not change the display priority of the facility icons (step ST15), and advances the sequence to step ST16 and then performs the above-mentioned map display.

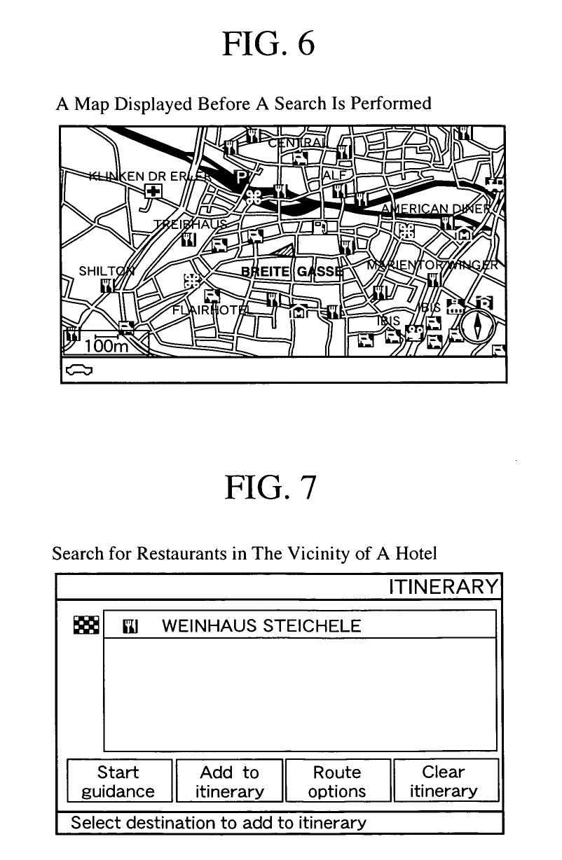

Next, changes in the screen which are implemented through the above-mentioned processes will be explained with reference to FIGS. 6 to 9. FIGS. 6 to 9 show examples of the screen which are used in English-speaking countries. FIG. 6 is a view showing a map before a search is performed. On this map, in addition to roads, restaurant icons each designated by a mark showing a knife and a fork, hotel icons each designated by a mark showing a bed, gas station icons each designated by a mark showing a fuel pump, movie theater icons each designated by a mark showing a motion picture camera, parking lot icons each designated by a mark showing a character P, hospital icons each designated by a mark showing a cross, and so on are displayed scatteringly.

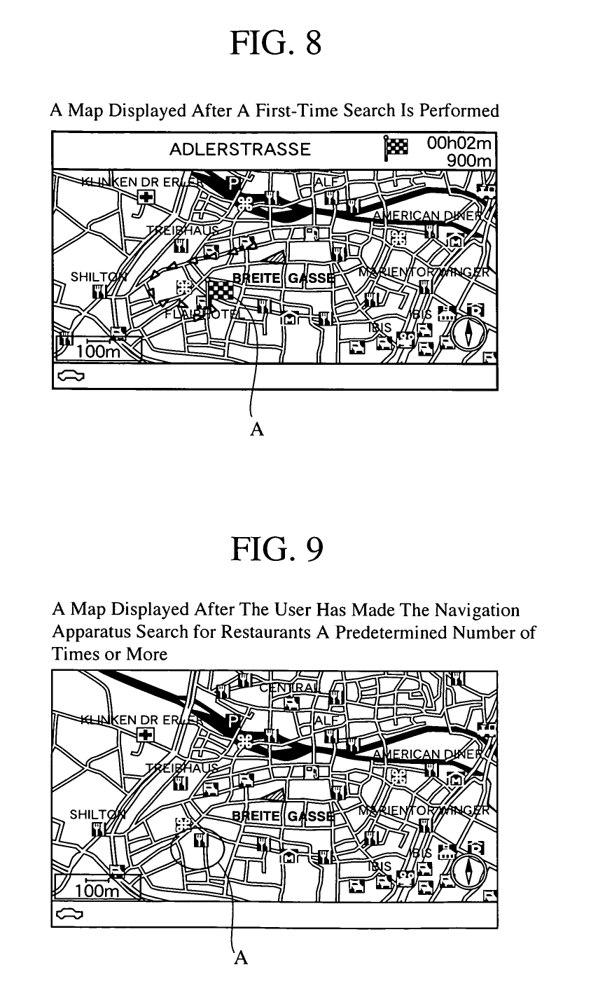

For example, when, on the map shown in this FIG. 6, the user instructs the navigation apparatus to search for nearby restaurants by using a menu screen as shown in FIG. 7, the map display device displays hotel icons on a priority basis, as shown at a point A of FIG. 8, on a map which the map display device has displayed after the first-time search because the display priority of hotel icons is higher than that of restaurant icons when the map has default settings (the display state of icons is not changed after the first-time search). FIG. 9 shows a map after the user has made a search for restaurants a predetermined number of times or greater. As shown at the point A of this FIG. 9, the hotel icon close to the restaurant icon not visible is made not visible while the restaurant icon is made visible.

As previously explained, the map display device in accordance with Embodiment 1 of the present invention judges whether or not the display condition for changing the display priorities of icons is satisfied, and, when the display condition is satisfied, further judges whether an icon to be displayed has an overlap with another icon, and, when an icon to be displayed has an overlap with another icon, automatically displays an icon which has been judged to satisfy the display condition on a priority basis. Therefore, by using the number of times that a search has been performed, a date, a search distance, a passenger, weather, or the like as the display condition, the map display device can provide good visibility and can also have user-friendness.

### INDUSTRIAL APPLICABILITY

As mentioned above, when an POI icon to be displayed on the map has an overlap with another POI icon, the map display device in accordance with the present invention automatically displays an icon which has been judged to satisfy the display condition on a priority basis. Therefore, because the map display device can provide good visibility and can also have user-friendness, the map display device is suitable for use in a vehicle-mounted navigation apparatus and so on.

1. A map display device comprising:
a display condition judging device for judging whether or not a display condition for changing display priorities of icons is satisfied;
an overlap judging device for judging whether an icon to be displayed has an overlap with another icon when said display condition judging device judges that the display condition is satisfied;
a display state changing device for, when said overlap judging device judges that an icon to be displayed has an overlap with another icon, changing the display priorities automatically in such a way that an icon which has been judged to satisfy the display condition by said display condition judging device is displayed on a priority basis; and
a display device for displaying icons according to the display priorities changed by said display state changing device.

2. The map display device according to claim 1, characterized in that the display controller judges whether or not the display condition for changing the display priorities of icons is satisfied on a basis of a number of times that a search of a POI (Point of Interest) has been performed.

3. The map display device according to claim 2, characterized in that the map display device has a screen transition controller for controlling a transition between screens according to an instruction from outside the map display device, and a storage device for storing, as screen transition information, information about a screen to which a previous screen is made to make a transition by control of said screen transition controller, and the display condition judging device counts the number of times that a search for the POI has been performed on a basis of the screen transition information stored in said storage device, and judges that the display condition for changing the display priorities of icons is satisfied when a result of said counting exceeds a predetermined number of times.

4. The map display device according to claim 1, characterized in that the display condition judging device judges whether or not the display condition for changing the display priorities of icons is satisfied on a basis of a date, a search distance, a passenger, or weather.
